(19) United States
(12) Patent Application Publication
(10) Pub. No.: US 2026/0180959 A1
(43) Pub. Date: Jun. 25, 2026

(54) DATA RETROSPECTIVE VERIFICATION METHOD AND APPARATUS

(71) Applicants: PROMOTING ERA TECHNOLOGY (BEIJING) CO., LTD., BEIJING (CN); HEBEI JUHE SUPERCOMPUTING SOFTWARE TECH CO., LTD., SHIJIAZHUANG CITY (CN)

(72) Inventors: GUANGYU CHEN, BEIJING (CN); SHUAI WANG, BEIJING (CN); DUOLAN LIU, BEIJING (CN)

(21) Appl. No.: 19/366,688

(22) Filed: Oct. 23, 2025

(30) Foreign Application Priority Data
Oct. 24, 2024 (CN) 202411491124.4

(51) Int. Cl. H04L 9/40

(52) U.S. Cl. CPC H04L 63/0428; H04L 63/105

(57) ABSTRACT

Provided are a data retrospective verification method and apparatus, relating to the technical field of data inspection and validation. The method includes the following steps: generating a unique and unalterable-evidence data label for evidence data through expanded information and an evidence element of the evidence data determined by an evidence-providing party during verification, storing the data label to an evidence-preserving party, and acquiring, by an evidence-acquiring party, a target data label from the evidence-preserving party in response to a data retrospective verification request, and verifying data according to the target data label to provide a more reliable and efficient data verification solution for MIME (Multipurpose Internet Mail Extensions) and S/MIME (Secure/MIME) application scenarios such as an email system and a file transfer protocol.

### CROSS-REFERENCE TO RELATED APPLICATION

This patent application claims the benefit and priority of Chinese Patent Application No. 202411491124.4 filed with the China National Intellectual Property Administration on Oct. 24, 2024, the disclosure of which is incorporated by reference herein in its entirety as part of the present application.

### TECHNICAL FIELD

The present disclosure relates to the technical field of data inspection and validation, and in particular to a data retrospective verification method and apparatus.

### BACKGROUND

With in-depth development of information technology, as a key platform for carrying important data, an email system and its various derivative systems under the technical standard system are increasingly widely used. These systems have not only gained widespread legal recognition globally but have also become core media of data interaction. Under the background of digital transformation in various fields, more and more data interaction behaviors are generated. Within application systems, data interaction facilitates data processing among internal components; among various application systems or devices, the data interaction enables cross-system or cross-device coordination; and among various organizations, the data interaction enables cross-organizational business collaboration.

The data standard of email is MIME (Multipurpose Internet Mail Extensions), which is primarily based on the specifications defined in RFC 2045 (MIME Part One: Format of Internet Message Bodies), RFC 2046 (MIME Part Two: Media Types), and RFC 2047 (MIME Part Three: Message Header Extensions for Non-ASCII Text). Initially developed for defining and representing format types of email attachments, the MIME standard has now been used in various scenarios involving data interaction on the Internet, such as, specifying a content type of web pages in HTTP (HyperText Transfer Protocol) transmission, specifying a data transmission format in WebServices, specifying request and response data formats in API (Application Programming Interface) communication, and restricting file types when the application system uploads files. Here, ASCII is a character encoding standard, which is used for the exchange of text between computers, communication devices and other electronic devices. On the basis of MIME, S/MIME (Secure/Multipurpose Internet Mail Extensions) is also developed. By combining MIME with PKI (Public Key Infrastructure) technology, data encryption and signature can be achieved to improve the security of data interaction.

Two typical characteristics of email data standards are data encapsulation and data exchange behavior. These two characteristics are manifested not only in email system scenarios involving server-to-server and server-to-client interactions, but have also been extended to instant messaging systems leveraging MIME-based encapsulated data exchange. In view of the universality of such data interaction behaviors, the capability for evidence preservation, retrospective auditing, inspection and validation of such data holding and interaction behaviors has become increasingly critical. Therefore, there is an urgent need to solve this technical problem.

### SUMMARY

In view of the foregoing problems, the present disclosure is put forward to provide a data retrospective verification method and apparatus for overcoming the above problems or at least partially solving the foregoing problems. The technical solution is as follows.

In a first aspect, a data retrospective verification method is provided, where data is encapsulated based on MIME standard or S/MIME standard, and the method includes the following steps:
defining an evidence-providing role, an evidence-preserving role and an evidence-acquiring role in advance, where the evidence-providing role includes one or more evidence-providing parties;
for any evidence-providing party in the one or more evidence-providing parties, providing, by the evidence-providing party, evidence data, determining expanded information and an evidence element based on the evidence data, combining the expanded information with the evidence element to generate a unique data label of the evidence data, submitting the data label to an evidence-preserving party corresponding to the evidence-preserving role, and storing, by the evidence-preserving party, the data label; where the evidence element includes a complete data fingerprint value and/or a segmented data fingerprint value obtained by calculating the evidence data by employing a preset digest algorithm and combining the MIME standard or the S/MIME standard; and
querying, by an evidence-acquiring party corresponding to the evidence-acquiring role, one or more data labels stored by the evidence-preserving party based on a verification condition in a data retrospective verification request in response to the data retrospective verification request to obtain a target data label, and then obtaining a verification result based on one or more of the expanded information, a complete data fingerprint value and a segmented data fingerprint value of the target data label.

In a possible implementation, the expanded information includes time, an identity and a behavior;
the behavior refers to an operation performed on the evidence data, including releasing, ingesting, holding or discarding;
the identity refers to a value that uniquely identifies an identity of an operator performing an operation of releasing, ingesting, holding or discarding on the evidence data; and
the time is a time value that generates the unique data label of the evidence data.

In a possible implementation, if providing the evidence data by the evidence-providing party is an operation of releasing the evidence data, the expanded information further includes a data receiver.

In a possible implementation, if providing the evidence data by the evidence-providing party is an operation of ingesting the evidence data, the expanded information further includes a data source party.

In a possible implementation, the method further includes:
traversing, by the evidence-providing party, a database or a fingerprint database held by the evidence-providing party for a specified fingerprint element, if current data matching the specified fingerprint element exists, determining expanded information of the current data based on the matched current data; combining the expanded information of the current data with the specified fingerprint element to generate a unique data label of the current data, submitting the data label to the evidence-preserving party corresponding to the evidence-preserving role, and storing the data label by the evidence-preserving party.

In a possible implementation, if the data retrospective verification request includes a request for confirming that first evidence data ingested by a first evidence-providing party is from a second evidence-providing party;
querying, by an evidence-acquiring party corresponding to the evidence-acquiring role, one or more data labels stored by the evidence-preserving party based on a verification condition in a data retrospective verification request in response to the data retrospective verification request to obtain a target data label, and then obtaining a verification result based on one or more of the expanded information, a complete data fingerprint value and a segmented data fingerprint value of the target data label, including:
calculating, by the evidence-acquiring party corresponding to the evidence-acquiring role, the first evidence data by employing the preset digest algorithm and combining the MIME standard or the S/MIME standard in response to the request for confirming that the first evidence data ingested by the first evidence-providing party is from the second evidence-providing party, thereby obtaining a complete data fingerprint value and/or a segmented data fingerprint value of the first evidence data;
searching for, by the evidence-acquiring party, at least one first data label matching the complete data fingerprint value and/or the segmented data fingerprint value of the first evidence data from the one or more data labels stored by the evidence-preserving party;
determining whether an identity of expanded information of the at least one first data label includes the second evidence-providing party;
if the identity of the expanded information of the at least one first data label includes the second evidence-providing party, determining whether a data receiver of the expanded information of the at least one first data label includes the first evidence-providing party; if the data receiver of the expanded information of the at least one first data label includes the first evidence-providing party, confirming that the first evidence data ingested by the first evidence-providing party is from the second evidence-providing party; otherwise, confirming that the first evidence data ingested by the first evidence-providing party is not from the second evidence-providing party; and
if the identity of the expanded information of at least one first data label does not include the second evidence-providing party, confirming that the first evidence data ingested by the first evidence-providing party is not from the second evidence-providing party.

In a possible implementation, if the data retrospective verification request includes a request for verifying that second evidence data released by the first evidence-providing party is sent to a third evidence-providing party,
querying, by an evidence-acquiring party corresponding to the evidence-acquiring role, one or more data labels stored by the evidence-preserving party based on a verification condition in a data retrospective verification request in response to the data retrospective verification request to obtain a target data label, and then obtaining a verification result based on one or more of the expanded information, a complete data fingerprint value and a segmented data fingerprint value of the target data label, including:
calculating, by the evidence-acquiring party corresponding to the evidence-acquiring role, the second evidence data by employing the preset digest algorithm and combining the MIME standard or the S/MIME standard in response to the request for verifying that the second evidence data released by the first evidence-providing party is sent to the third evidence-providing party, thereby obtaining a complete data fingerprint value and/or a segmented data fingerprint value of the second evidence data;
searching for, by the evidence-acquiring party, at least one second data label matching the complete data fingerprint value and/or the segmented data fingerprint value of the second evidence data from one or more data labels stored by the evidence-preserving party;
determining whether an identity of expanded information of the at least one second data label includes the first evidence-providing party, whether a behavior of the expanded information of the at least one second data label is data releasing, and whether the data receiver is the third evidence-providing party;
if the identity of the expanded information of the at least one second data label includes the first evidence-providing party, the behavior of the expanded information of the at least one second data label is data releasing, and the data receiver is the third evidence-providing party, determining that the second evidence data released by the first evidence-providing party is sent to the third evidence-providing party; and
if the identity of the expanded information of the at least one second data label does not include the first evidence-providing party or the behavior of the expanded information of the at least one second data label is not data releasing, determining that the first evidence-providing party does not release the second evidence data.

In a possible implementation, if the data retrospective verification request includes a request for verifying that the first evidence-providing party holds or discards third evidence data;
querying, by an evidence-acquiring party corresponding to the evidence-acquiring role, one or more data labels stored by the evidence-preserving party based on a verification condition in a data retrospective verification request in response to the data retrospective verification request to obtain a target data label, and then obtaining a verification result based on one or more of the expanded information, a complete data fingerprint value and a segmented data fingerprint value of the target data label, including:
calculating, by the evidence-acquiring party corresponding to the evidence-acquiring role, the third evidence data by employing the preset digest algorithm and combining the MIME standard or the S/MIME standard in response to the request for verifying that the first evidence-providing party holds or discards the third evidence data, thereby obtaining a complete data fingerprint value and/or a segmented data fingerprint value of the third evidence data;
searching for, by the evidence-acquiring party, at least one third data label matching the complete data fingerprint value and/or the segmented data fingerprint value of the third evidence data from one or more data labels stored by the evidence-preserving party;
determining whether an identity of expanded information of the at least one third data label includes the first evidence-providing party;
if the identity of the expanded information of the at least one third data label includes the first evidence-providing party, checking a behavior of the expanded information of the at least one third data label; if the behavior of the expanded information of the at least one third data label is data discarding, determining that the first evidence-providing party discards the third evidence data; and if the behavior of the expanded information of the at least one third data label is data holding, determining that the first evidence-providing party holds the third evidence data; and
if the identity of the expanded information of the at least one third data label does not include the first evidence-providing party, determining that the first evidence-providing party does not hold or discard the third evidence data.

In a possible implementation, if the data retrospective verification request includes a request for verifying whether fourth data issued and held by the first evidence-providing party is earlier than fourth data issued and held by the second evidence-providing party;
querying, by an evidence-acquiring party corresponding to the evidence-acquiring role, one or more data labels stored by the evidence-preserving party based on a verification condition in a data retrospective verification request in response to the data retrospective verification request to obtain a target data label, and then obtaining a verification result based on one or more of the expanded information, a complete data fingerprint value and a segmented data fingerprint value of the target data label, including:
calculating, by the evidence-acquiring party corresponding to the evidence-acquiring role, fourth evidence data by employing the preset digest algorithm and combining the MIME standard or the S/MIME standard in response to the request for verifying whether the fourth data issued and held by the first evidence-providing party is earlier than the fourth data issued and held by the second evidence-providing party, thereby obtaining a complete data fingerprint value and/or a segmented data fingerprint value of the fourth evidence data;
searching for, by the evidence-acquiring party, a fourth data label that matches the complete data fingerprint value and/or the segmented data fingerprint value of the fourth evidence data and has an identity of the first evidence-providing party and a fifth data label that matches the complete data fingerprint value and/or the segmented data fingerprint value of the fourth evidence data and has an identity of the second evidence-providing party from one or more data labels stored by the evidence-preserving party; and
if time of expanded information of the fourth data label is earlier than that of expanded information of the fifth data label, determining that the fourth data issued and held by the first evidence-providing party is earlier than the fourth data issued and held by the second evidence-providing party.

In a second aspect, a data retrospective verification apparatus is provided, where data is encapsulated based on MIME standard or S/MIME standard, and the apparatus includes:
a defining module, configured to define an evidence-providing role, an evidence-preserving role, and an evidence-acquiring role in advance, where the evidence-providing role includes one or more evidence-providing parties;
any evidence-providing party in the one or more evidence-providing parties, configured to provide evidence data, determine expanded information and an evidence element based on the evidence data, combine the expanded information with the evidence element to generate a unique data label of the evidence data, and to submit the data label to an evidence-preserving party corresponding to the evidence-preserving role; where the evidence element includes a complete data fingerprint value and/or a segmented data fingerprint value obtained by calculating the evidence data by employing a preset digest algorithm and combining the MIME standard or the S/MIME standard;
an evidence-preserving party, configured to store one or more data labels; and
an evidence-acquiring party corresponding to the evidence-acquiring role, configured to query the one or more data labels stored by the evidence-preserving party based on a verification condition in a data retrospective verification request in response to the data retrospective verification request to obtain a target data label, thereby obtaining a verification result based on one or more of the expanded information, a complete data fingerprint value and a segmented data fingerprint value of the target data label.

In a possible implementation, the expanded information includes time, an identity and a behavior;
the behavior refers to an operation performed on the evidence data, including releasing, ingesting, holding or discarding;
the identity refers to a value that uniquely identifies an identity of an operator performing an operation of releasing, ingesting, holding or discarding on the evidence data; and
the time is a time value that generates a unique data label of the evidence data.

In a possible implementation, if providing the evidence data by the evidence-providing party is an operation of releasing the evidence data, the expanded information further includes a data receiver.

In a possible implementation, if providing the evidence data by the evidence-providing party is an operation of ingesting the evidence data, the expanded information further includes a data source party.

In a possible implementation, the evidence-providing party is also configured to:
traverse a database or a fingerprint database held by the evidence-providing party for a specified fingerprint element; determine expanded information of the current data based on the matched current data if current data matching the specified fingerprint element exists; combine the expanded information of the current data with the specified fingerprint element to generate a unique data label of the current data, and submit the data label to the evidence-preserving party corresponding to the evidence-preserving role, where the data label is stored by the evidence-preserving party.

In a possible implementation, if the data retrospective verification request includes a request for confirming that first evidence data ingested by a first evidence-providing party is from a second evidence-providing party, the evidence-acquiring party is further configured to:
calculate the first evidence data by using the preset digest algorithm and combining the MIME standard and/or S/MIME standard in response to the request for confirming that the first evidence data ingested by the first evidence-providing party is from the second evidence-providing party, and then obtaining a complete data fingerprint value and/or a segmented data fingerprint value of the first evidence data;
search for at least one first data label matching the complete data fingerprint value and/or the segmented data fingerprint value of the first evidence data from one or more data labels stored by the evidence-preserving party;
determine whether an identity of expanded information of the at least one first data label includes the second evidence-providing party;
determine whether a data receiver of the expanded information of the at least one first data label includes the first evidence-providing party if the identity of the expanded information of the at least one first data label includes the second evidence-providing party; confirm that the first evidence data ingested by the first evidence-providing party is from the second evidence-providing party if the data receiver of the expanded information of the at least one first data label includes the first evidence-providing party; otherwise, confirm that the first evidence data ingested by the first evidence-providing party is not from the second evidence-providing party; and
confirm that the first evidence data ingested by the first evidence-providing party is not from the second evidence-providing party if the identity of the expanded information of at least one first data label does not include the second evidence-providing party.

In a possible implementation, if the data retrospective verification request includes a request for verifying that second evidence data released by the first evidence-providing party is sent to a third evidence-providing party, the evidence-acquiring party is further configured to:
calculate the second evidence data by employing the preset digest algorithm and combining the MIME standard or the S/MIME standard in response to the request for verifying that the second evidence data released by the first evidence-providing party is sent to the third evidence-providing party, thereby obtaining a complete data fingerprint value and/or a segmented data fingerprint value of the second evidence data;
search for at least one second data label matching the complete data fingerprint value and/or the segmented data fingerprint value of the second evidence data from one or more data labels stored by the evidence-preserving party;
determine whether an identity of expanded information of the at least one second data label includes the first evidence-providing party, whether a behavior of the expanded information of the at least one second data label is data releasing, and whether the data receiver is the third evidence-providing party;
determine that the second proof data released by the second evidence-providing party is sent to the third evidence-providing party if the identity of the expanded information of the at least one second data label includes the first evidence-providing party, the behavior of the expanded information of the at least one second data label is data releasing, and the data receiver is the third evidence-providing party; and
determine that the first evidence-providing party does not release the second proof data if the identity of the expanded information of the at least one second data label does not include the first evidence-providing party or the behavior of the expanded information of the at least one second data label is not data releasing.

In a possible implementation, if the data retrospective verification request includes a request for verifying that the first evidence-providing party holds or discards third evidence data, the evidence-acquiring party is further configured to:
calculate the third evidence data by employing the preset digest algorithm and combining the MIME standard or the S/MIME standard in response to the request for verifying that the first evidence-providing party holds or discards third evidence data, and then obtain a complete data fingerprint value and/or a segmented data fingerprint value of the third evidence data;
search for at least one third data label matching the complete data fingerprint value and/or the segmented data fingerprint value of the third evidence data from one or more data labels stored by the evidence-preserving party;
determine whether an identity of expanded information of at least one third data label includes the first evidence-providing party;
check a behavior of the expanded information of the at least one third data label if the identity of the expanded information of the at least one third data label does not include the first evidence-providing party, determine that the first evidence-providing party discards the third evidence data if the behavior of the expanded information of the at least one third data label is data discarding; determine that the first evidence-providing party holds the third evidence data if the behavior of the expanded information of the at least one third data label is data holding; and
determine that the first evidence-providing party does not hold or discard the third evidence data if the identity of the expanded information of the at least one third data label does not include the first evidence-providing party.

In a possible implementation, if the data retrospective verification request includes a request for verifying whether fourth data issued and held by the first evidence-providing party is earlier than fourth data issued and held by the second evidence-providing party, the evidence-acquiring party is further configured to:
calculate fourth evidence data by employing the preset digest algorithm and combining the MIME standard or the S/MIME standard in response to the request for verifying whether the fourth data issued and held by the first evidence-providing party is earlier than the fourth data issued and held by the second evidence-providing party, and then obtain a complete data fingerprint value and/or a segmented data fingerprint value of the fourth evidence data;
search for a fourth data label that matches the complete data fingerprint value and/or the segmented data fingerprint value of the fourth evidence data and has an identity of the first evidence-providing party, and a fifth data label that matches the complete data fingerprint value and/or the segmented data fingerprint value of the fourth evidence data and has an identity of the second evidence-providing party from one or more data labels stored by the evidence-preserving party; and
determine that the fourth data issued and held by the first evidence-providing party is earlier than the fourth data issued and held by the second evidence-providing party if time of expanded information of the fourth data label is earlier than that of expanded information of the fifth data label.

By means of the foregoing technical solution, embodiments of the present disclosure provide a data retrospective verification method and apparatus. The method includes the following steps: generating a unique and unalterable-evidence data label for evidence data through expanded information and an evidence element of the evidence data determined by an evidence-providing party during verification, storing the data label to an evidence-preserving party, and acquiring, by an evidence-acquiring party, a target data label from the evidence-preserving party in response to a data retrospective verification request, and verifying data according to the target data label to provide a more reliable and efficient data verification solution for MIME and S/MIME application scenarios such as an email system and a file transfer protocol. In addition, because the verification is carried out through a data label, storage resource is effectively saved, the security of data content is enhanced, and the efficiency of verification response is improved. Furthermore, the data labels are stored in the evidence-preserving party, and the evidence-acquiring party obtains the target data label from the evidence-preserving party and then verifies the data according to the target data label. This enhances the traceability of the data and avoids the complexity of PKI management.

Further, the expanded information of the data label includes time, an identity, and a behavior. That is, the data label records an operation of releasing, ingesting, holding or discarding the evidence data, and the identity of an operator performing the releasing, ingesting, holding or discarding operation on the evidence data. In this way, the evidence-preserving party is responsible for storing these data labels, achieving logical decoupling between data state change records and the evidence-providing parties, thereby enabling flexible adaptation to various data flow scenarios. In a data verification link, the evidence-acquiring party can quickly access data labels involved in all stages of the whole process of specific data from generation to extinction (including releasing, ingesting, holding and discarding) from the evidence-preserving party, which fundamentally changes the perspective of conventional business-level verification to a micro-level of data state changes, and greatly enhances the security, traceability, and accuracy of the data flow process. Therefore, more robust data protection and higher verification efficiency are provided for MIME and S/MIME application scenarios such as an email system and a file transfer protocol.

### BRIEF DESCRIPTION OF THE DRAWINGS

To describe the technical solution of embodiments of the present disclosure more clearly, the accompanying drawings used for the description of the embodiments of the present disclosure are briefly introduced below.

FIG. 1 is a flowchart of a data retrospective verification method according to an embodiment of the present disclosure;

FIG. 2 is a structural diagram of a relationship among an evidence-providing role, an evidence-preserving role and an evidence-acquiring role according to an embodiment of the present disclosure; and

FIG. 3 is a structural diagram of a data retrospective verification apparatus according to an embodiment of the present disclosure.

### DETAILED DESCRIPTION OF THE EMBODIMENTS

Example embodiments of the present disclosure are described in more detail below with reference to the accompanying drawings. Although example embodiments of the present disclosure are shown in the accompanying drawings, it should be understood that the present disclosure can be embodied in various forms and should not be construed as limited to the embodiments set forth here. In contrast, these embodiments are provided for a more thorough and complete understanding of the present disclosure, and completely conveying the scope of the present disclosure to those skilled in the art.

It should be noted that the terms “first” and “second” in the description and claims of the present disclosure and the foregoing accompanying drawings intend to distinguish similar objects but do not necessarily indicate a specific order or sequence. It should be understood that the data termed in such a way are interchangeable in proper circumstances so that embodiments of the present disclosure described herein can be implemented in other orders than the order illustrated or described herein. Moreover, the term “include” and any other variants are to be interpreted as an open-ended term meaning “including but not limited to”.

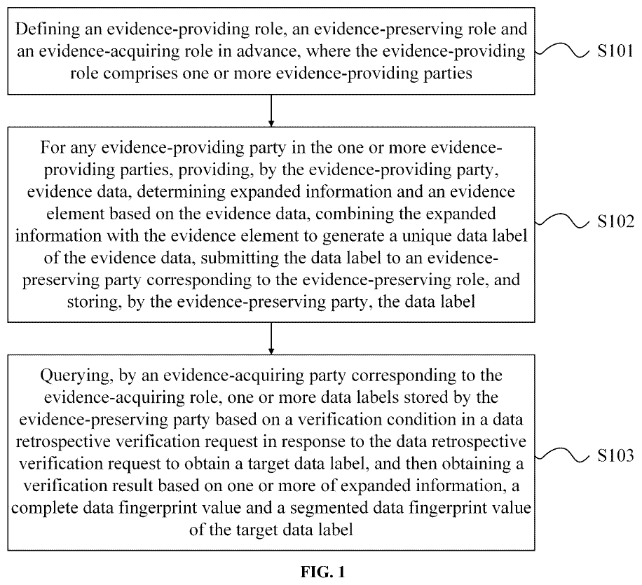

To solve the foregoing technical problems, an embodiment of the present disclosure provides a data retrospective verification method, where the data here is encapsulated based on MIME standard or S/MIME standard. As shown in FIG. 1, the data retrospective verification method includes the following steps S101 to S103:
S101: an evidence-providing role, an evidence-preserving role and an evidence-acquiring role are defined in advance, where the evidence-providing role includes one or more evidence-providing parties.
S102: for any evidence-providing party in the one or more evidence-providing parties, the evidence-providing party provides evidence data, determines expanded information and an evidence element based on the evidence data, then combines the expanded information with the evidence element to generate a unique data label of the evidence data, and submits the data label to an evidence-preserving party corresponding to the evidence-preserving role, where the data label is stored by the evidence-preserving party, the evidence element includes a complete data fingerprint value and/or a segmented data fingerprint value obtained by calculating the evidence data by employing a preset digest algorithm and combining the MIME standard or the S/MIME standard.
S103: an evidence-acquiring party corresponding to the evidence-acquiring role queries one or more data labels stored by the evidence-preserving party based on a verification condition in a data retrospective verification request in response to the data retrospective verification request to obtain a target data label, thereby obtaining a verification result based on one or more of expanded information, a complete data fingerprint value and a segmented data fingerprint value of the target data label.

In this embodiment, a unique and unalterable data label for evidence data is generated through expanded information and an evidence element of the evidence data determined by an evidence-providing party during verification, the data label is stored to an evidence-preserving party, and an evidence-acquiring party acquires a target data label from the evidence-preserving party in response to a data retrospective verification request, and then the data is verified according to the target data label to provide a more reliable and efficient data verification solution for MIME and S/MIME application scenarios such as an email system and file transfer. In addition, because the verification is carried out through a data label, storage resource is effectively saved, the security of data content is enhanced, and the efficiency of verification response is improved. Furthermore, the data label is stored in the evidence-preserving party, and the evidence-acquiring party obtains the target data label from the evidence-preserving party and then verifies the data according to the target data label, which enhances the traceability of the data and avoids the complexity of PKI management.

In the foregoing step S102, the evidence data provided by the evidence-providing party is encapsulated based on the MIME standard or S/MIME standard, thereby obtaining different MIME types and corresponding data content in the evidence data based on the MIME standard or S/MIME standard. Afterwards, complete data content of the evidence data can be calculated by employing the preset digest algorithm and combining the MIME standard and/or S/MIME standard to obtain a complete data fingerprint value; and the data content of different MIME types of the evidence data can be calculated by employing the preset digest algorithm and combining the MIME standard and/or S/MIME standard to obtain segmented data fingerprint values corresponding to different MIME types.

The MIME types here are configured to define a data format in an email, a webpage or other Internet documents. The MIME type is composed of two parts: a type and a subtype, which are separated by a slash (/). The type defines a general category of data, while the subtype provides more specific information.

The following are some examples of common MIME types and their subtypes:
(1) “text/” stands for text data.
“text/plain” stands for an ordinary text file, such as TXT (Text) file.
“text/html” stands for an HTML (HyperText Markup Language) document.
(2) “image/” stands for image data.
“image/jpeg” stands for an image in a JPEG (Joint Photographic Experts Group) format.
“image/png” stands for an image in a PNG (Portable Network Graphics) format.
“image/gif” stands for an image in a GIF (Graphics Interchange Format) format.
(3) “audio/” stands for audio data.
“audio/mpeg” stands for an MPEG (Moving Pictures Experts Group) audio, such as an MP3 file.
“audio/wav” stands for a WAV (Waveform Audio File Format) audio file.
(4) “video/” stands for video data.
(4) “video/mp4” stands for an MP4 video file.
(5) “application/” stands for binary data, which is generally used for applications.
“application/json” stands for JSON (JavaScript Object Notation, a Lightweight Data Exchange Format) data.
“application/octet-stream” is a general type for unknown binary data.
(6) “multipart/” is a composite type used to combine multiple different types of data.
“multipart/form-data” is used for the submitting of form data, such as file uploading.
“multipart/byteranges” is used for representing multiple parts of the document.

It should be noted that the foregoing examples are only schematic and are not intended to limit this embodiment.

The preset digest algorithm here may be MD5 (Message Digest Algorithm), SHA (Secure Hash Algorithm)-1, SHA-2, SHA-128, SHA-256, and custom algorithms, which are not limited in this embodiment.

An embodiment of the present disclosure provides a possible implementation, the expanded information mentioned in the step S102 may include time, an identity, and a behavior. The behavior here refers to an operation performed on the evidence data, comprising releasing, ingesting, holding or discarding; the identity refers to a value that uniquely identifies an identity of an operator performing an operation of releasing, ingesting, holding or discarding on the evidence data; and the time is a time value that generates a unique data label of the evidence data.

The evidence-providing party corresponding to the evidence-providing role may provide a data label of the evidence data to the evidence-preserving party corresponding to the evidence-preserving role through a network protocol, such as HTTP and FTP (File Transfer Protocol), or a storage medium, such as a hard disk or USB (Universal Serial Bus). The evidence-preserving party stores the data label in a retrieval way (such as a database, a file system, and catalog), and the data labels stored by the evidence-preserving party include four data states, which are data releasing, data ingesting, data holding, and data discarding.

Here, a behavior that the evidence data enters the evidence-providing party is data ingesting, a behavior that the evidence data is sent out from the evidence-providing party or acquired to the external is data releasing, a behavior that the evidence data is possessed by the evidence-providing party is data holding, a behavior that the evidence data is not possessed by the evidence-providing party is data non-holding, and a behavior that the evidence data is removed from the evidence-providing party is data discarding.

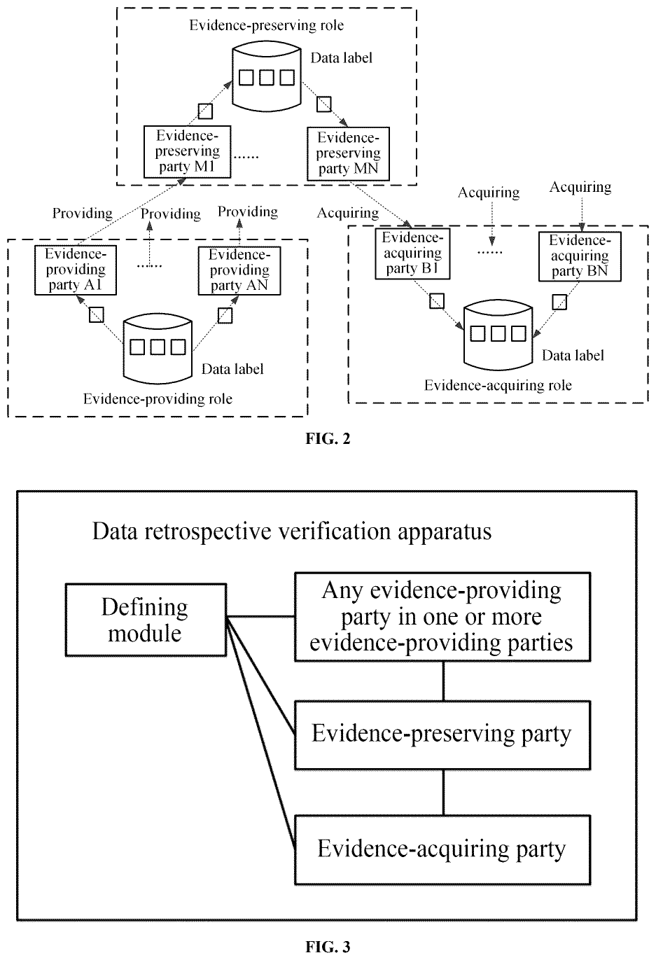

FIG. 2 is a structural diagram of a relationship among an evidence-providing role, an evidence-preserving role and an evidence-acquiring role according to an embodiment of the present disclosure. The evidence-providing role may include one or more evidence-providing parties (such as evidence-providing parties A1 to AN, where N is a positive integer). Any evidence-providing party in the one or more evidence-providing parties may serve as a provider of the evidence data.

The evidence-preserving role may include one or more evidence-preserving parties (such as evidence-preserving parties M1 to MN). The evidence-preserving party, as a storage party of the data label, can be in any party for data exchange, or can be independent of any party for data exchange, which is not limited in this embodiment.

The evidence-acquiring role may also include one or more evidence-acquiring parties (such as evidence-acquiring parties B1 to BN), the evidence-acquiring party may be various types of business software, client software, servers, gateways, email routing devices, management and control systems that query, hold, exchange, manage, control, or handle data flows of data encapsulated based on MIME/S/MIME standard, and status and behaviors of the data, or any systems that store, transmit, or process these data. The evidence-acquiring party may also include institutions, entities, and personnel roles, which are not limited in this embodiment.

During verification, the evidence-preserving party provides a data label to the evidence-acquiring party, the evidence-acquiring party can also query related data labels through retrievable fields (such as the complete data fingerprint value, the segmented data fingerprint value, the identity, and the behavior) to obtain the target data label, and then a verification result can be obtained based on one or more of the identity, behavior, date, complete data fingerprint value and segmented data fingerprint value of the target data label.

An embodiment of the present disclosure provides a possible implementation, in the foregoing step S102, if providing the evidence data by the evidence-providing party is an operation of releasing the evidence data, the expanded information may further include a data receiver, or may include a data source party. In this case, a relationship chain among the evidence-providing parties is established, and a clear and verifiable data transmission behavior chain or data state evolution chain is formed.

An embodiment of the present disclosure provides a possible implementation, in the foregoing step S102, if providing the evidence data by the evidence-providing party is an operation of ingesting the evidence data, the expanded information may further include a data source party, which can also establish a relationship chain among the evidence-providing parties, thereby forming a clear and verifiable data transmission behavior chain or data state evolution chain.

An embodiment of the present disclosure provides a possible implementation, the expanded information include not only time, identity and behavior which are three required fields, but also the data receiver or the data source party. In addition, one or more fields, such as data size and data encryption level, can also be expanded according to the actual situation, which are not limited in this embodiment.

In foregoing step S102, for any evidence-providing party in the one or more evidence-providing parties, the method of performing evidence preservation on the evidence data provided by the evidence-providing party is specifically introduced. In a possible implementation, the method of performing evidence preservation on the specified fingerprint element may include the following step a1:
Step a1: the evidence-providing party traverses a database or a fingerprint database held by the evidence-providing party, if current data matching the specified fingerprint element exists, expanded information of the current data is determined based on the matched current data; the expanded information of the current data and the specified fingerprint element are combined to generate a unique data label of the current data, the data label is submitted to the evidence-preserving party corresponding to the evidence-preserving role, and the data label is stored by the evidence-preserving party.

In this step, the specified fingerprint element may be provided by the evidence-providing party, or exist independently. For example, the specified fingerprint element can be queried from a system of the evidence-preserving party, or an existing fingerprint acquired from other channels, which is not limited in this embodiment.

For the data held by the evidence-providing party, the data held by the evidence-providing party can be calculated by employing the preset digest algorithm and combining the MIME standard and/or the S/MIME standard to obtain a complete data fingerprint value and/or segmented data fingerprint value; the complete data fingerprint value and/or the segmented data fingerprint value of the data held by the evidence-providing party are traversed, if there is the complete data fingerprint value and/or the segmented data fingerprint value matching the specified fingerprint element, the data corresponding to the complete data fingerprint value and/or the segmented data fingerprint value matching the specified fingerprint element can be used as the current data matching the specified fingerprint element.

For the fingerprint database held by the evidence-providing party, the fingerprint database held by the evidence-providing party can be traversed, if there is a fingerprint matching the specified fingerprint element, the data corresponding to the fingerprint matching the specified fingerprint element can be used as the current data matching the specified fingerprint element.

It should be noted that the specified fingerprint element is also obtained by calculating specified data using the preset digest algorithm.

An embodiment of the present disclosure provides a possible implementation, if the data retrospective verification request in step S103 includes a request for confirming that first evidence data ingested by a first evidence-providing party is from a second evidence-providing party. In step S103, the evidence-acquiring party corresponding to the evidence-acquiring role, in response to the data retrospective verification request, queries one or more data labels stored by the evidence-preserving party based on a verification condition in the data retrospective verification request to obtain a target data label, thereby obtaining a verification result based on one or more of the expanded information, a complete data fingerprint value and a segmented data fingerprint value of the target data label, which specifically includes the following steps b1 to b5:
Step b1: the evidence-acquiring party corresponding to the evidence-acquiring role calculates the first evidence data by employing the preset digest algorithm and combining the MIME standard or the S/MIME standard in response to the request for confirming that the first evidence data ingested by the first evidence-providing party is from the second evidence-providing party, thereby obtaining a complete data fingerprint value and/or a segmented data fingerprint value of the first evidence data.
Step b2: the evidence-acquiring party searches for at least one first data label matching the complete data fingerprint value and/or the segmented data fingerprint value of the first evidence data from one or more data labels stored by the evidence-preserving party.
Step b3: whether an identity of expanded information of the at least one first data label includes a second evidence-providing party is determined.
Step b4: if the identity of the expanded information of the at least one first data label includes the second evidence-providing party, whether a data receiver of the expanded information of the at least one first data label includes the first evidence-providing party is determined; if the data receiver of the expanded information of the at least one first data label includes the first evidence-providing party, it is confirmed that the first evidence data ingested by the first evidence-providing party is from the second evidence-providing party; otherwise, it is confirmed that the first evidence data ingested by the first evidence-providing party is not from the second evidence-providing party.
Step b5: if the identity of the expanded information of the at least one first data label does not include the second evidence-providing party, it is confirmed that the first evidence data ingested by the first evidence-providing party is not from the second evidence-providing party.

In this embodiment, whether the first evidence data ingested by the first evidence-providing party is from the second evidence-providing party can be safely, accurately and efficiently confirmed and verified.

An embodiment of the present disclosure provides a possible implementation, if the data retrospective verification request in step S103 includes a request for verifying that second evidence data released by the first evidence-providing party is sent to a third evidence-providing party. In step S103, the evidence-acquiring party corresponding to the evidence-acquiring role, in response to the data retrospective verification request, queries one or more data labels stored by the evidence-preserving party based on a verification condition in the data retrospective verification request to obtain a target data label, thereby obtaining a verification result based on one or more of the expanded information, a complete data fingerprint value and a segmented data fingerprint value of the target data label, which specifically includes the following steps c1 to c5:
Step c1: the evidence-acquiring party corresponding to the evidence-acquiring role calculates the second evidence data by employing the preset digest algorithm and combining the MIME standard or the S/MIME standard in response to the request for verifying that the second evidence data released by the first evidence-providing party is sent to the third evidence-providing party, thereby obtaining a complete data fingerprint value and/or a segmented data fingerprint value of the second evidence data.
Step c2: the evidence-acquiring party searches for at least one second data label matching the complete data fingerprint value and/or the segmented data fingerprint value of the second evidence data from one or more data labels stored by the evidence-preserving party.
Step c3: whether an identity of expanded information of the at least one second data label comprises the first evidence-providing party, whether a behavior of the expanded information of the at least one second data label is data releasing, and whether the data receiver is the third evidence-providing party are determined.
Step c4: if the identity of the expanded information of the at least one second data label includes the first evidence-providing party, the behavior of the expanded information of the at least one second data label is data releasing, and the data receiver is the third evidence-providing party, it is determined that the second evidence data released by the second evidence-providing party is sent to the third evidence-providing party;
Step c5: if the identity of the expanded information of the at least one second data label does not include the first evidence-providing party or the behavior of the expanded information of the at least one second data label is not data releasing, it is determined that the first evidence-providing party does not release the second evidence data.

In this embodiment, whether the second evidence data released by the first evidence-providing party is sent to a third evidence-providing party can be safely, accurately and efficiently verified.

An embodiment of the present disclosure provides a possible implementation, if the data retrospective verification request in step S103 includes a request for verifying that the first evidence-providing party holds for discards third evidence data. In step S103, the evidence-acquiring party corresponding to the evidence-acquiring role, in response to the data retrospective verification request, queries one or more data labels stored by the evidence-preserving party based on a verification condition in the data retrospective verification request to obtain a target data label, thereby obtaining a verification result based on one or more of the expanded information, a complete data fingerprint value and a segmented data fingerprint value of the target data label, which specifically includes the following steps d1 to d5.
Step d1: the evidence-acquiring party corresponding to the evidence-acquiring role calculates the third evidence data by employing the preset digest algorithm and combining the MIME standard or the S/MIME standard in response to the request for verifying that the first evidence-providing party holds or discards the third evidence data, and then obtaining a complete data fingerprint value and/or a segmented data fingerprint value of the third evidence data.
Step d2: the evidence-acquiring party searches for at least one third data label matching the complete data fingerprint value and/or the segmented data fingerprint value of the third evidence data from one or more data labels stored by the evidence-preserving party.
Step d3: whether an identity of expanded information of the at least one third data label includes the first evidence-providing party is determined.
Step d4: If the identity of the expanded information of the at least one third data label includes the first evidence-providing party, a behavior of the expanded information of the at least one third data label is checked, if the behavior of the expanded information of the at least one third data label is data discarding, it is determined that the first evidence-providing party discards the third evidence data; and if the behavior of the expanded information of the at least one third data label is data holding, it is determined that the first evidence-providing party holds the third evidence data.
Step d5: if the identity of the expanded information of the at least one third data label does not include the first evidence-providing party, it is determined that the first evidence-providing party does not hold or discard the third evidence data.

In this embodiment, whether the first evidence-providing party holds for discards third evidence data can be safely, accurately and efficiently verified.

An embodiment of the present disclosure provides a possible implementation, if the data retrospective verification request in step S103 includes a request for verifying whether fourth data issued and held by the first evidence-providing party is earlier than fourth data issued and held by the second evidence-providing party. In step S103, the evidence-acquiring party corresponding to the evidence-acquiring role, in response to the data retrospective verification request, queries one or more data labels stored by the evidence-preserving party based on a verification condition in the data retrospective verification request to obtain a target data label, thereby obtaining a verification result based on one or more of the expanded information, a complete data fingerprint value and a segmented data fingerprint value of the target data label, which specifically includes the following steps e1 to e3.
Step e1: the evidence-acquiring party corresponding to the evidence-acquiring role calculates fourth evidence data by employing the preset digest algorithm and combining the MIME standard or the S/MIME standard in response to the request for verifying whether the fourth data issued and held by the first evidence-providing party is earlier than the fourth data issued and held by the second evidence-providing party, thereby obtaining a complete data fingerprint value and/or a segmented data fingerprint value of the fourth evidence data.
Step e2: the evidence-acquiring party searches for a fourth data label that matches the complete data fingerprint value and/or the segmented data fingerprint value of the fourth evidence data and has an identity of the first evidence-providing party, and a fifth data label that matches the complete data fingerprint value and/or the segmented data fingerprint value of the fourth evidence data and has an identity of the second evidence-providing party from one or more data labels stored by the evidence-preserving party.
Step e3: if time of expanded information of the fourth data label is earlier than that of expanded information of the fifth data label, it is determined that the fourth data issued and held by the first evidence-providing party is earlier than the fourth data issued and held by the second evidence-providing party.

In this embodiment, whether the fourth data issued and held by the first evidence-providing party is earlier than the fourth data issued and held by the second evidence-providing party can be safely, accurately and efficiently verified.

The evidence-providing role may include one or more evidence-providing parties, such as an evidence-providing party 1, an evidence-providing party 2, an evidence-providing party 3, an evidence-providing party 4 . . . , and an evidence-providing party N, where N is a positive integer. The first evidence-providing party, the second evidence-providing party and the third evidence-providing party mentioned in foregoing embodiments are only schematic, and do not specifically mean that the first evidence-providing party is the evidence-providing party 1, the second evidence-providing party is the evidence-providing party 2, and the third evidence-providing party is the evidence-providing party 3. In actual application scenarios, the first evidence-providing party may be the evidence-providing party 1, the evidence-providing party 2, the evidence-providing party 3, or the evidence-providing party N, the second evidence-providing party may be other evidence-providing parties except the first evidence-providing party, and the second evidence-providing party may be other evidence-providing parties except the first evidence-providing party and the second evidence-providing party.

For example, in a scenario when the data retrospective verification request includes a request for confirming that the first evidence data ingested by the first evidence-providing party is from the second evidence-providing party, the first evidence-providing party may be the evidence-providing party 2, and the second evidence-providing party may be the evidence-providing party 4.

In a scenario when the data retrospective verification request includes a request for verifying whether the fourth data issued and held by the first evidence-providing party is earlier than the fourth data issued and held by the second evidence-providing party, the first evidence-providing party may be the evidence-providing party 1, and the second evidence-providing party may be the evidence-providing party 3.

It should be noted that the foregoing example is only schematic and is not intended to limit this embodiment.

Various implementations of each link of the embodiment shown in FIG. 1 are introduced above, and the data retrospective verification method according to the embodiment of the present disclosure is further explained through specific embodiments.

Scenario example 1: An evidence-providing party A1 corresponding to the evidence-providing role sends a message M (for example, email) in the form of MIME to A2, and A2 automatically acquires original data of the message at this time.

The email data in the form of MIME is shown below:
X-ANY-EXTHEADER:
Reply-To:“=?gbk?B?wfW24MC8?=” <xxx@anymacro.com>
X-Send-Id:1723099968.ac7a1910355639c6904e2993cc20809814719
From:“−?gbk?B?wfW24MC8?=” <xxx@anymacro.com>
Date:Thu,08 Aug 2024 14:52:45+0800(CST)
MIME-version: 1.0
X-srcuser:xxx@anymacro.com
X-ANYWEBIP:IP_K
To:“=?utf-8?b?546L5YW16bKB?=” <aaaaa@anymacro.com>
Subject:=?gbk?B?d2Fzbc/gudjWqsq2tKKxuA==?=
Content-Type:multipart/mixed;
boundary=“14719.66b46b402b468.8ffc5632c87b09bc.anymacro”
--14719.66b46b402b468.8ffc5632c87b09bc.anymacro
Content-Type:text/html;charset=gbk
Content-Transfer-Encoding:base64
zfW5pLrDo708ZG12PixzcGFuIHN0eWx1PST3aG10ZS1zcGFiZTpwcmUiPgk8L3NwYW4+uL28/srHd2Fzbc/gudilxNaqyra0orG4xNrI3aGjPC9kaXY+
--14719.66b46b402b468.8ffc5632c87b09bc.anymacro
Content-Type:application/octet-stream;name=“=?gbk?B?d2Fzbdagyra0orG4LmRvY3g=?=”
Content-Transfer-Encoding:base64
Content-Disposition:attachment;filename=“=?gbk?B?d2Fzbdagyra0orG4LmRvY3g=?=”

In the foregoing email data in the form of MIME, X-ANY-EXTHEADER is a non-standard email header, which is generally used for a specific email system or application; the field Reply-To specifies which address to reply to when replying to an email, where an address here is “xxx@anymacro.com”, but Base64 (an encoding method for representing binary data based on 64 printable characters) format encoded by GBK (a Chinese character encoding standard) is used. X-Send-Id is a unique identifier generated when this email is sent; From is an email address of a sender, which is also “xxx@anymacro.com”, and uses a Base64 format encoded by GBK; Date is date and time when the email is sent; MIME-version is an identifier of an MIME version followed by the email; X-srcuser is an email address of a sending user; X-ANYWEBIP is a network IP (Internet Protocol) address used when the email is sent, IP_K is schematic and is not limited here in this embodiment; To is an email address of a recipient, which uses a Base64 format encoded by UTF-8; Subject is a subject of the email, which uses the Base64 format encoded by GBK; Content-Type specifies a type of the email content, which is multipart/mixed here, indicating that the email includes multiple parts; and boundary is a boundary marker used to separate different parts in the email.

The email content is divided into two parts: the first part is text/html type, including text content in the HTML format, and the text is encoded in the Base64 format, and the decoded content is HTML code. The second part is application/octet-stream type, which is used for the sending of a binary file. A file name is specified here (using the Base64 format encoded by GBK), and the content is also Base64 encoded, which indicates that the email contains an attachment, and the specific content of the attachment needs to be viewed after being decoded.

For the evidence-providing party A1, the complete original data can be encrypted by employing the preset digest algorithm to obtain a complete data fingerprint value H1. The original data is composed of two MIME types, it is necessary to obtain each MIME type and encrypt the data of each MIME type to obtain segmented data fingerprint values H2 and H3 respectively. The expanded information is generated based on the original data, including time, an identity (a value that can uniquely identity the evidence-providing party A1), a behavior (data releasing), and the data receiver A2. The complete data fingerprint value H1, the segmented data fingerprints H2 and H3 are combined with the expanded information to generate a data label, and then the generated data label is stored by the evidence-preserving party M1.

The data label of the email data in the form of MIME is as follows:
Complete data: complete data fingerprint value H1;
Segmented data:
1) MIME type (text/html) and data content, segmented data fingerprint H2;
2) MIME type (application/octet-stream) and data content, segmented data fingerprint H3;
Expanded information:
1) time, a time value of generating the data label, which may be Thu,08Aug202414:52:45+0800(CST);
2) identity, addresser: xxx@anymacro.com;
3) behavior, sending mail, data releasing;
4) data receiver, recipient: aaaaa@anymacro.com.

The evidence-providing party A2, after receiving the message M, performs evidence preservation on the data label of the message M, and the generated data label is stored by the evidence-preserving party M1.

If the evidence-providing party A2 needs to verify the confirmatory of the behavior of the evidence-providing party A1, an evidence-acquiring party B1 corresponding to the evidence-acquiring role can acquire the complete data fingerprint value H1 in the data label generated by the evidence-providing party A2, retrieves at least one data label consistent with H1 in the evidence-providing party M1, and compares whether an identity in the at least one data label includes the evidence-providing party A1 and whether the data receiver includes the evidence-providing party A2. If the identity in the at least one data label includes the evidence-providing party A1 and the data receiver includes the evidence-providing party A2, the behavior confirmatory verification passes, and the verification process operates without relying on PKI and does not require validation of digital certificate validity.

Scenario example 2: All historically held data in the evidence-providing parties A1 and A2 have been stored in the evidence-preserving party, both A1 and A2 publish an original artwork in MIME message format. Upon comparison, the two original artworks show seventy percent similarity. With A1 and A2 both claiming originality, authentication is required to determine which party created the artwork earlier. The evidence-acquiring party B1 intervenes to obtain data labels D(1) and D(2) generated during the initial creation of both artworks from the evidence-preserving party M1. After comparison, since a timestamp in D(1) is earlier than that in D(2), it can be concluded that the artwork of A2 is created later than that of A1.

Scenario example 3: All held and discarded data in the evidence-providing party A have been stored in the evidence-preserving party M, a company where the evidence-providing party A is located needs to delete specific data periodically, the evidence-acquiring party B needs to periodically verify whether these specific data are deleted within specified time. During verification, the evidence-acquiring party B acquires the data label D when the file is discarded or deleted from the evidence-preserving party M, and checks whether the time in the expanded information of the data label D is within the specified time limit.

Scenario example 4: In a data exchange scenario, a business system (the evidence-providing party) A1 and a business system (the evidence-providing party) A2 can achieve data interoperability through interactive interfaces. A1 system is responsible for encapsulating files needing to be archived in the form of MIME message, and calling an interface of the A2 system through an interactive protocol for data transmission. A2 system is responsible for acquiring, storing and processing these encapsulated data. Data exchange behaviors between A1 and A2 have been stored in the evidence-preserving party M.

A recent abnormal case has been identified: a certain data file that the A1 system claims to have submitted to the A2 system is inconsistent with the one stored in the A2 system, making the retrospecting and finding process complicated and difficult. To solve this problem, the evidence-acquiring party B is introduced into this solution, B is responsible for acquiring a data label D(A1) generated when the A1 system sends a request, as well as a data label D(A2) generated when the A2 system stores data. D(A1) and D(A2) each include key information such as a timestamp of data exchange and a complete data fingerprint value, which are used to verify the accuracy of data. By comparing the complete data fingerprint values in D(A1) and D(A2), the evidence-acquiring party B confirms whether the data is tampered during transmission. In addition, by comparing the timestamps, B finds that time in D(A1) is earlier than that in D(A2), which proves that A1 system sends data to A2 system at the specified time. By further analyzing the identities, data receivers and data source parties of the expanded information in D(A1) and D(A2), B can confirm whether the data received and stored by A2 system is consistent with the original data sent by A1 system, thereby solving the problem of data inconsistency and clarifying the responsibility.

This embodiment provides more effective data protection and verification efficiency for the MIME and S/MIME application scenarios such as an email system and a file transfer protocol, and fully meets the strict requirements in fields including legal compliance, historical record retention, and security auditing.

It should be noted that the numerical order of the steps in the foregoing embodiments does not imply the sequence of their execution. The execution sequence of various processes should be determined by their functionality and inherent logic, and the numerical order of the steps shall not be construed as limiting the implementation process of the embodiments of the present disclosure. In practical application, all possible implementations described above may be arbitrarily combined in any manner to form possible embodiments of the present disclosure, which will not be described in detail here.

Based on the data retrospective verification method provided based on each embodiment, an embodiment of the present disclosure further provides a data retrospective verification apparatus based on the same inventive concept.

FIG. 3 is a structural diagram of a data retrospective verification apparatus according to an embodiment of the present disclosure. As shown in FIG. 3, the data retrospective verification apparatus specifically may include a defining module, any evidence-providing party in one or more evidence-providing parties, an evidence-preserving party, and an evidence-acquiring party corresponding to an evidence-acquiring role.

The defining module is configured to define an evidence-providing role, an evidence-preserving role, and an evidence-acquiring role in advance, where the evidence-providing role includes one or more evidence-providing parties;
any evidence-providing party in the one or more evidence-providing parties is configured to provide evidence data, determine expanded information and an evidence element based on the evidence data, combine the expanded information with the evidence element to generate a unique data label of the evidence data, and submit the data label to an evidence-preserving party corresponding to the evidence-preserving role; where the evidence element includes a complete data fingerprint value and/or a segmented data fingerprint value obtained by calculating the evidence data by employing a preset digest algorithm and combining the MIME standard or the S/MIME standard;
the evidence-preserving party is configured to store one or more data labels; and
the evidence-acquiring party corresponding to the evidence-acquiring role is configured to query the one or more data labels stored by the evidence-preserving party based on a verification condition in a data retrospective verification request in response to the data retrospective verification request to obtain a target data label, thereby obtaining a verification result based on one or more of the expanded information, a complete data fingerprint value and a segmented data fingerprint value of the target data label.

An embodiment of the present disclosure provides a possible implementation, the expanded information includes time, an identity and a behavior;
the behavior refers to an operation performed on the evidence data, including releasing, ingesting, holding or discarding;
the identity refers to a value that uniquely identifies an identity of an operator performing an operation of releasing, ingesting, holding or discarding on the evidence data; and
the time is a time value that generates a unique data label of the evidence data.

An embodiment of the present disclosure provides a possible implementation, if providing the evidence data by the evidence-providing party is an operation of releasing the evidence data, the expanded information further includes a data receiver.

An embodiment of the present disclosure provides a possible implementation, if providing the evidence data by the evidence-providing party is an operation of ingesting the evidence data, the expanded information further includes a data source party.

An embodiment of the present disclosure provides a possible implementation, the evidence-providing party is further configured to:
traverse a database or a fingerprint database held by the evidence-providing party for a specified fingerprint element, determine expanded information of the current data based on the matched current data if current data matching the specified fingerprint element exists, combine the expanded information of the current data with the specified fingerprint element to generate a unique data label of the current data, and submit the data label to the evidence-preserving party corresponding to the evidence-preserving role, where the data label is stored by the evidence-preserving party.

An embodiment of the present disclosure provides a possible implementation, if the data retrospective verification request includes a request for confirming that first evidence data ingested by a first evidence-providing party is from a second evidence-providing party, the evidence-acquiring party is further configured to:
calculate the first evidence data by using the preset digest algorithm and combining the MIME standard and/or S/MIME standard in response to the request for confirming that the first evidence data ingested by the first evidence-providing party is from the second evidence-providing party, thereby obtaining a complete data fingerprint value and/or a segmented data fingerprint value of the first evidence data;
search for at least one first data label matching the complete data fingerprint value and/or the segmented data fingerprint value of the first evidence data from one or more data labels stored by the evidence-preserving party;
determine whether an identity of expanded information of the at least one first data label includes the second evidence-providing party;
determine whether a data receiver of the expanded information of the at least one first data label includes the first evidence-providing party if the identity of the expanded information of the at least one first data label includes the second evidence-providing party; confirm that the first evidence data ingested by the first evidence-providing party is from the second evidence-providing party if the data receiver of the expanded information of the at least one first data label includes the first evidence-providing party; otherwise, confirm that the first evidence data ingested by the first evidence-providing party is not from the second evidence-providing party; and
confirm that the first evidence data ingested by the first evidence-providing party is not from the second evidence-providing party if the identity of the expanded information of at least one first data label does not include the second evidence-providing party.

An embodiment of the present disclosure provides a possible implementation, if the data retrospective verification request includes a request for verifying that second evidence data released by the first evidence-providing party is sent to a third evidence-providing party, the evidence-acquiring party is further configured to:
calculate the second evidence data by employing the preset digest algorithm and combining the MIME standard or the S/MIME standard in response to the request for verifying that the second evidence data released by the first evidence-providing party is sent to the third evidence-providing party, thereby obtaining a complete data fingerprint value and/or a segmented data fingerprint value of the second evidence data;
search for at least one second data label matching the complete data fingerprint value and/or the segmented data fingerprint value of the second evidence data from one or more data labels stored by the evidence-preserving party;
determine whether an identity of expanded information of the at least one second data label includes the first evidence-providing party, whether a behavior of the expanded information of the at least one second data label is data releasing, and whether the data receiver is the third evidence-providing party;
determine that the second evidence data released by the second evidence-providing party is sent to the third evidence-providing party if the identity of the expanded information of the at least one second data label includes the first evidence-providing party, the behavior of the expanded information of the at least one second data label is data releasing, and the data receiver is the third evidence-providing party; and
determine that the first evidence-providing party does not release the second evidence data if the identity of the expanded information of the at least one second data label does not include the first evidence-providing party or the behavior of the expanded information of the at least one second data label is not data releasing.

An embodiment of the present disclosure provides a possible implementation, if the data retrospective verification request includes a request for verifying that the first evidence-providing party holds or discards third evidence data, the evidence-acquiring party is further configured to:
calculate the third evidence data by employing the preset digest algorithm and combining the MIME standard or the S/MIME standard in response to the request for verifying that the first evidence-providing party holds or discards third evidence data, thereby obtaining a complete data fingerprint value and/or a segmented data fingerprint value of the third evidence data;
search for at least one third data label matching the complete data fingerprint value and/or the segmented data fingerprint value of the third evidence data from one or more data labels stored by the evidence-preserving party;
determine whether an identity of expanded information of at least one third data label includes the first evidence-providing party;
check a behavior of the expanded information of the at least one third data label if the identity of the expanded information of the at least one third data label includes the first evidence-providing party, determine that the first evidence-providing party discards the third evidence data if the behavior of the expanded information of the at least one third data label is data discarding; determine that the first evidence-providing party holds the third evidence data if the behavior of the expanded information of the at least one third data label is data holding; and
determine that the first evidence-providing party does not hold or discard the third evidence data if the identity of the expanded information of the at least one third data label does not include the first evidence-providing party.

An embodiment of the present disclosure provides a possible implementation, if the data retrospective verification request includes a request for verifying whether fourth data issued and held by the first evidence-providing party is earlier than fourth data issued and held by the second evidence-providing party, the evidence-acquiring party is further configured to:
calculate fourth evidence data by employing the preset digest algorithm and combining the MIME standard or the S/MIME standard in response to the request for verifying whether the fourth data issued and held by the first evidence-providing party is earlier than the fourth data issued and held by the second evidence-providing party, and then obtain a complete data fingerprint value and/or a segmented data fingerprint value of the fourth evidence data;
search for a fourth data label that matches the complete data fingerprint value and/or the segmented data fingerprint value of the fourth evidence data and has an identity of the first evidence-providing party, and a fifth data label that matches the complete data fingerprint value and/or the segmented data fingerprint value of the fourth evidence data and has an identity of the second evidence-providing party from one or more data labels stored by the evidence-preserving party; and
determine that the fourth data issued and held by the first evidence-providing party is earlier than the fourth data issued and held by the second evidence-providing party if time of expanded information of the fourth data label is earlier than that of expanded information of the fifth data label.

Based on the same inventive concept, an embodiment of the present disclosure further provides an electronic device, including a memory and a processor, where a computer program is stored in the memory, and the processor is configured to run the computer program to execute the data retrospective verification method of any foregoing embodiment.

Based on the same inventive concept, an embodiment of the present disclosure further provides a storage medium, where a computer program is stored in the storage medium, and the processor is configured to run the computer program to execute the data retrospective verification method of any foregoing embodiment.

Those skilled in the art may understand clearly that a specific working process of the system, apparatus and module described above may refer to a corresponding process in the foregoing method embodiment, and details are not described herein again for the sake of brevity.

It can be understood by those of ordinary skill in the art that the technical solutions in the present disclosure essentially, or all or some of the technical solutions may be implemented in the form of a software product. The computer software product is stored in a storage medium and includes several instructions for instructing an electronic device (for example, a personal computer, a server, a network device, or the like) to perform all or some of the steps of the methods described in the embodiments of the present disclosure when running the program instruction. The foregoing storage medium includes: any medium that can store program code, such as a USB flash drive, a removable hard disk, a read-only memory (ROM), a random access memory (RAM), a magnetic disk, or an optical disc etc.

Alternatively, all or some of the steps of the foregoing method embodiments can be accomplished by hardware related program instruction (such as a personal computer, a server, or a network device), the program instruction can be stored in a computer-readable storage medium, and when the program instruction is executed by a processor of the electronic device, the electronic device is configured to execute all or some of the steps of the methods described in various embodiments of the present disclosure.

The foregoing embodiments are merely used to describe the technical solutions of the present disclosure, rather than limitation. Although the present disclosure is described in detail with reference to the foregoing embodiments, a person of ordinary skill in the art should understand that: within the spirit and principle of the present disclosure, the technical solutions described in the foregoing embodiments may still be modified, or some or all technical features thereof may be equivalently replaced. These modifications or substitutions do not make the corresponding technical solutions deviate from the scope of protection of the present disclosure.

What is claimed is:

1. A data retrospective verification method, wherein data is encapsulated based on Multipurpose Internet Mail Extensions (MIME) standard or Secure/Multipurpose Internet Mail Extensions (S/MIME) standard, and the method comprises:
defining an evidence-providing role, an evidence-preserving role and an evidence-acquiring role in advance, wherein the evidence-providing role comprises one or more evidence-providing parties;
for any evidence-providing party in the one or more evidence-providing parties, providing, by the evidence-providing party, evidence data, determining expanded information and an evidence element based on the evidence data, combining the expanded information with the evidence element to generate a unique data label of the evidence data, submitting the data label to an evidence-preserving party corresponding to the evidence-preserving role, and storing, by the evidence-preserving party, the data label; wherein the evidence element comprises a complete data fingerprint value and/or a segmented data fingerprint value obtained by calculating the evidence data by employing a preset digest algorithm and combining the MIME standard or the S/MIME standard;
calculating, by an evidence-acquiring party corresponding to the evidence-acquiring role, the data by employing the preset digest algorithm and combining the MIME standard or the S/MIME standard in response to a data retrospective verification request, thereby obtaining a complete data fingerprint value and/or a segmented data fingerprint value of the data, querying one or more data labels stored by the evidence-preserving party to obtain a target data label matching the complete data fingerprint value and/or the segmented data fingerprint value of the data, and then obtaining a verification result based on expanded information of the target data label;
wherein the expanded information comprises time, an identity and a behavior;
the behavior refers to an operation performed on the evidence data, comprising releasing, ingesting, holding or discarding;
the identity refers to a value that uniquely identifies an identity of an operator performing an operation of releasing, ingesting, holding or discarding on the evidence data; and
the time is a time value that generates the unique data label of the evidence data.

2. The method according to claim 1, wherein if providing the evidence data by the evidence-providing party is an operation of releasing the evidence data, the expanded information further comprises a data receiver;
if providing the evidence data by the evidence-providing party is an operation of ingesting the evidence data, the expanded information further comprises a data source party.

3. The method according to claim 1, wherein the method further comprises:
traversing, by the evidence-providing party, a database or a fingerprint database held by the evidence-providing party for a specified fingerprint element, if current data matching the specified fingerprint element exists, determining expanded information of the current data based on the matched current data; combining the expanded information of the current data with the specified fingerprint element to generate a unique data label of the current data, submitting the data label to the evidence-preserving party corresponding to the evidence-preserving role, and storing the data label by the evidence-preserving party.

4. The method according to claim 2, wherein if the data retrospective verification request comprises a request for confirming that first evidence data ingested by a first evidence-providing party is from a second evidence-providing party,
calculating, by the evidence-acquiring party corresponding to the evidence-acquiring role, the data by employing the preset digest algorithm and combining the MIME standard or the S/MIME standard in response to the data retrospective verification request, thereby obtaining the complete data fingerprint value and/or the segmented data fingerprint value of the data, querying the one or more data labels stored by the evidence-preserving party to obtain the target data label matching the complete data fingerprint value and/or the segmented data fingerprint value of the data, and then obtaining the verification result based on the expanded information of the target data label, comprises:
calculating, by the evidence-acquiring party corresponding to the evidence-acquiring role, the first evidence data by employing the preset digest algorithm and combining the MIME standard or the S/MIME standard in response to the request for confirming that the first evidence data ingested by the first evidence-providing party is from the second evidence-providing party, thereby obtaining a complete data fingerprint value and/or a segmented data fingerprint value of the first evidence data;
searching for, by the evidence-acquiring party, at least one first data label matching the complete data fingerprint value and/or the segmented data fingerprint value of the first evidence data from the one or more data labels stored by the evidence-preserving party;
determining whether an identity of expanded information of the at least one first data label comprises the second evidence-providing party;
if the identity of the expanded information of the at least one first data label comprises the second evidence-providing party, determining whether a data receiver of the expanded information of the at least one first data label comprises the first evidence-providing party; if the data receiver of the expanded information of the at least one first data label comprises the first evidence-providing party, confirming that the first evidence data ingested by the first evidence-providing party is from the second evidence-providing party; otherwise, confirming that the first evidence data ingested by the first evidence-providing party is not from the second evidence-providing party; and
if the identity of the expanded information of the at least one first data label does not comprise the second evidence-providing party, confirming that the first evidence data ingested by the first evidence-providing party is not from the second evidence-providing party.

5. The method according to claim 2, wherein if the data retrospective verification request comprises a request for verifying that second evidence data released by the first evidence-providing party is sent to a third evidence-providing party,
calculating, by the evidence-acquiring party corresponding to the evidence-acquiring role, the data by employing the preset digest algorithm and combining the MIME standard or the S/MIME standard in response to the data retrospective verification request, thereby obtaining the complete data fingerprint value and/or the segmented data fingerprint value of the data, querying the one or more data labels stored by the evidence-preserving party to obtain the target data label matching the complete data fingerprint value and/or the segmented data fingerprint value of the data, and then obtaining the verification result based on the expanded information of the target data label, comprises:
calculating, by the evidence-acquiring party corresponding to the evidence-acquiring role, the second evidence data by employing the preset digest algorithm and combining the MIME standard or the S/MIME standard in response to the request for verifying that the second evidence data released by the first evidence-providing party is sent to the third evidence-providing party, thereby obtaining a complete data fingerprint value and/or a segmented data fingerprint value of the second evidence data;
searching for, by the evidence-acquiring party, at least one second data label matching the complete data fingerprint value and/or the segmented data fingerprint value of the second evidence data from the one or more data labels stored by the evidence-preserving party;
determining whether an identity of expanded information of the at least one second data label comprises the first evidence-providing party, whether a behavior of the expanded information of the at least one second data label is data releasing, and whether the data receiver is the third evidence-providing party;
if the identity of the expanded information of the at least one second data label comprises the first evidence-providing party, the behavior of the expanded information of the at least one second data label is data releasing, and the data receiver is the third evidence-providing party, determining that the second evidence data released by the first evidence-providing party is sent to the third evidence-providing party; and
if the identity of the expanded information of the at least one second data label does not comprise the first evidence-providing party or the behavior of the expanded information of the at least one second data label is not data releasing, determining that the first evidence-providing party does not release the second evidence data.

6. The method according to claim 1, wherein if the data retrospective verification request comprises a request for verifying that the first evidence-providing party holds or discards third evidence data,
calculating, by the evidence-acquiring party corresponding to the evidence-acquiring role, the data by employing the preset digest algorithm and combining the MIME standard or the S/MIME standard in response to the data retrospective verification request, thereby obtaining the complete data fingerprint value and/or the segmented data fingerprint value of the data, querying the one or more data labels stored by the evidence-preserving party to obtain the target data label matching the complete data fingerprint value and/or the segmented data fingerprint value of the data, and then obtaining the verification result based on the expanded information of the target data label, comprises:
calculating, by the evidence-acquiring party corresponding to the evidence-acquiring role, the third evidence data by employing the preset digest algorithm and combining the MIME standard or the S/MIME standard in response to the request for verifying that the first evidence-providing party holds or discards the third evidence data, thereby obtaining a complete data fingerprint value and/or a segmented data fingerprint value of the third evidence data;
searching for, by the evidence-acquiring party, at least one third data label matching the complete data fingerprint value and/or the segmented data fingerprint value of the third evidence data from the one or more data labels stored by the evidence-preserving party;
determining whether an identity of expanded information of the at least one third data label comprises the first evidence-providing party;
if the identity of the expanded information of the at least one third data label comprises the first evidence-providing party, checking a behavior of the expanded information of the at least one third data label; if the behavior of the expanded information of the at least one third data label is data discarding, determining that the first evidence-providing party discards the third evidence data; and if the behavior of the expanded information of the at least one third data label is data holding, determining that the first evidence-providing party holds the third evidence data; and
if the identity of the expanded information of the at least one third data label does not comprise the first evidence-providing party, determining that the first evidence-providing party does not hold or discard the third evidence data.

7. The method according to claim 1, wherein if the data retrospective verification request comprises a request for verifying whether fourth data issued and held by the first evidence-providing party is earlier than fourth data issued and held by the second evidence-providing party;
calculating, by the evidence-acquiring party corresponding to the evidence-acquiring role, the data by employing the preset digest algorithm and combining the MIME standard or the S/MIME standard in response to the data retrospective verification request, thereby obtaining the complete data fingerprint value and/or the segmented data fingerprint value of the data, querying the one or more data labels stored by the evidence-preserving party to obtain the target data label matching the complete data fingerprint value and/or the segmented data fingerprint value of the data, and then obtaining the verification result based on the expanded information of the target data label, comprises:
calculating, by the evidence-acquiring party corresponding to the evidence-acquiring role, fourth evidence data by employing the preset digest algorithm and combining the MIME standard or the S/MIME standard in response to the request for verifying whether the fourth data issued and held by the first evidence-providing party is earlier than the fourth data issued and held by the second evidence-providing party, thereby obtaining a complete data fingerprint value and/or a segmented data fingerprint value of the fourth evidence data;
searching for, by the evidence-acquiring party, a fourth data label that matches the complete data fingerprint value and/or the segmented data fingerprint value of the fourth evidence data and has an identity of the first evidence-providing party, and a fifth data label that matches the complete data fingerprint value and/or the segmented data fingerprint value of the fourth evidence data and has an identity of the second evidence-providing party from the one or more data labels stored by the evidence-preserving party; and
if time of expanded information of the fourth data label is earlier than that of expanded information of the fifth data label, determining that the fourth data issued and held by the first evidence-providing party is earlier than the fourth data issued and held by the second evidence-providing party.

8. A data retrospective verification apparatus, wherein data is encapsulated based on Multipurpose Internet Mail Extensions (MIME) standard or Secure/Multipurpose Internet Mail Extensions (S/MIME) standard, and the apparatus comprises:
a defining module, configured to define an evidence-providing role, an evidence-preserving role, and an evidence-acquiring role in advance, wherein the evidence-providing role comprises one or more evidence-providing parties;
any evidence-providing party in the one or more evidence-providing parties, configured to provide evidence data, determine expanded information and an evidence element based on the evidence data, combine the expanded information with the evidence element to generate a unique data label of the evidence data, and submit the data label to an evidence-preserving party corresponding to the evidence-preserving role; wherein the evidence element comprises a complete data fingerprint value and/or a segmented data fingerprint value obtained by calculating the evidence data by employing a preset digest algorithm and combining the MIME standard or the S/MIME standard;
the evidence-preserving party, configured to store one or more data labels; and
an evidence-acquiring party corresponding to the evidence-acquiring role, configured to calculate the data by employing the preset digest algorithm and combining the MIME standard or the S/MIME standard in response to a data retrospective verification request, thereby obtaining a complete data fingerprint value and/or a segmented data fingerprint value of the data, query one or more data labels stored by the evidence-preserving party to obtain a target data label matching the complete data fingerprint value and/or the segmented data fingerprint value of the data, thereby obtaining a verification result based on expanded information of the target data label;
wherein the expanded information comprises time, an identity and a behavior;
the behavior refers to an operation performed on the evidence data, comprising releasing, ingesting, holding or discarding;
the identity refers to a value that uniquely identifies an identity of an operator performing an operation of releasing, ingesting, holding or discarding on the evidence data; and
the time is a time value that generates the unique data label of the evidence data.
